(19) United States
(12) Patent Application Publication
(10) Pub. No.: US 2009/0086112 A1
(43) Pub. Date: Apr. 2, 2009

(54) PROJECTION TYPE LIQUID CRYSTAL DISPLAY AND COMPENSATION PLATE

(75) Inventors: Hirokazu Kaida, Kanagawa (JP); Shinya Watanabe, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/235,678

(22) Filed: Sep. 23, 2008

(30) Foreign Application Priority Data
Sep. 28, 2007 (JP) 2007-254167

(51) Int. Cl. G02F 1/13363

(52) U.S. Cl. 349/9

(57) ABSTRACT

A projection type liquid crystal display includes a light source, a reflective liquid crystal element modulating light from the light source based on an image signal, a polarization beam splitter disposed on an optical path between the light source and the liquid crystal element, a compensation plate disposed on an optical path between the liquid crystal element and the beam splitter, and projection means for projecting light impinging thereon through an optical path extending through the compensation plate and the beam splitter upon a screen, the light impinging upon the projection means after being modulated by the liquid crystal element. The compensation plate has in-plane retardation Re being one-fourth the wavelength of the incident light and retardation RthL in the thickness direction which is equal to retardation RthC in the thickness direction of the liquid crystal element in absolute value and is the reverse of the retardation RthC in polarity.

### CROSS REFERENCES TO RELATED APPLICATIONS

The present invention contains subject matter related to Japanese Patent Application JP 2007-254167 filed in the Japanese Patent Office on Sep. 28, 2007, the entire contents of which being incorporated herein by reference.

### BACKGROUND OF THE INVENTION

1. Field of the Invention

The present invention relates to a projection type liquid crystal display including a reflective liquid crystal element and a polarization beam splitter and a compensation plate used in such a projection type liquid crystal display.

2. Description of the Related Art

Projection type liquid crystal displays (liquid crystal projectors) have come into wide use. In such displays, light incident on a liquid crystal element exits the element after being spatially modulated according to an electrical signal applied to the liquid crystal element, and the exiting light is collected and projected to display an image. In general, such a projection type liquid crystal display includes a lamp and a collection mirror serving as a light source, and the display also includes an illumination optical system for collecting light emitted from the light source and causing the light to impinge upon the liquid crystal element. The light is spatially modulated by the liquid crystal element and projected on a screen through a projection lens.

Known projection type liquid crystal displays as thus described include displays employing a reflective liquid crystal element as a light bulb and employing a polarization beam splitter (PBS) as a polarization selecting element (see JP-A-10-26756 (Patent Document 1) for example).

### SUMMARY OF THE INVENTION

In Patent Document 1, it is proposed to dispose a quarter wave plate on an optical path between a reflective liquid crystal element and a polarization beam splitter to suppress an angular deviation of a polarization axis attributable to the direction in which the light impinges upon the polarization beam splitter. Thus, leakage light toward the screen is reduced when black is displayed. As a result, luminance can be kept low when black is displayed to achieve improved contrast.

However, even in such a projection type liquid crystal display, an angular deviation of a polarization axis of modulated light may change into a different state due to a minute phase difference that exists in the reflective liquid crystal element. It has not been possible to compensate for such a change in the state of an angular deviation of a polarization axis sufficiently using only a quarter wave plate. In such a case, leakage light has not been sufficiently suppressed, and the effect of improving contrast has been only insufficiently achieved.

A possible solution is to provide another compensation plate in addition to such a quarter wave plate for compensating for a minute phase difference in a reflective liquid crystal element. However, it seems difficult to suppress leakage light sufficiently by simply providing such an additional compensation plate when consideration is to be paid for both of correction of an angular deviation of a polarization axis and compensation for a minute phase difference.

The invention was made taking the above-described problems into consideration, and it is desirable to provide a projection type liquid crystal display including a reflective liquid crystal element and a polarization beam splitter and having contrast higher than that of displays according to the related art. It is also desirable to provide a compensation plate for such a display.

According to an embodiment of the invention, there is provided a projection type liquid crystal display including a light source, a reflective liquid crystal element modulating light from the light source based on an image signal, a polarization beam splitter disposed on an optical path between the light source and the reflective liquid crystal element, a compensation plate disposed on an optical path between the reflective liquid crystal element and the polarization beam splitter, and projection means for projecting light impinging thereupon through an optical path extending through the compensation plate and the beam splitter upon a screen, the light impinging upon the projection means after being modulated by the reflective liquid crystal element. The compensation plate has in-plane retardation Re which is one-fourth the wavelength of light impinging upon the compensation plate. The compensation plate has retardation RthL in the direction of the thickness of the compensation plate. The retardation RthL is equal to retardation RthC in the thickness direction of the reflective liquid crystal element in absolute value and is the reverse of the retardation RthC in polarity.

According to another embodiment of the invention, there is provided a compensation plate of a projection type liquid crystal display including a light source, a reflective liquid crystal element modulating light from the light source based on an image signal, a polarization beam splitter disposed on an optical path between the light source and the reflective liquid crystal element, and projection means for projecting light impinging thereupon through an optical path extending through the compensation plate and the beam splitter upon a screen, the light impinging upon the projection means after being modulated by the reflective liquid crystal element. The compensation plate is used on an optical path between the reflective liquid crystal element and the polarization beam splitter. The compensation plate has in-plane retardation Re equivalent to one-fourth the wavelength of light impinging upon the plate and retardation RthL in the thickness direction of the plate. The retardation RthL is equal to retardation RthC in the thickness direction of the reflective liquid crystal element in absolute value and is the reverse of the retardation RthC in polarity.

In the projection type liquid crystal display of the embodiment, light emitted from the light source is polarization-split by the polarization beam splitter, and one of resultant polarization components of the light impinges upon the reflective liquid crystal element through the compensation plate. The incident light is modulated by the reflective liquid crystal element based on an image signal, and the modulated light impinges upon the projection means through the compensation plate and the polarization beam splitter. The incident light is projected upon a screen by the projection means to display an image based on the image signal. Since the in-plane retardation Re of the compensation plate is one-fourth the wavelength of light incident thereupon, the compensation plate serves as a quarter wave plate when viewed in the frontal direction of the display. As a result, an angular deviation of a polarization axis of light impinging upon the polarization beam splitter attributable to the impinging direction is suppressed, and leakage light toward the screen is reduced when black is displayed. The retardation RthL in the thickness direction of the compensation plate is equal to the retardation RthC in the thickness direction of the reflective liquid crystal element in absolute value and is the reverse of the retardation RthC in polarity. Therefore, the compensation plate cancels a minute phase difference in the reflective liquid crystal element. As a result, compensation is made for a change in the state of an angular deviation of a polarization axis of light modulated by the reflective liquid crystal element, whereby a further reduction in leakage light toward the screen is achieved when black is displayed. The single compensation plate provides the function of compensating for an angular deviation of a polarization axis and the function of compensating for a minute phase difference in the reflective liquid crystal element as thus described. It is therefore possible to avoid interfacial reflection of incident light which can occur, for example, when a quarter wave plate and a phase difference compensation plate are provided separately.

The compensation plate of the embodiment serves as a quarter wave plate when viewed in the frontal direction thereof since it has in-plane retardation Re which is one-fourth the wavelength of incident light. As a result, an angular deviation of a polarization axis attributable to the direction of incidence of light impinging upon the polarization beam splitter is suppressed, and leakage light toward the screen is reduced. The retardation RthL in the thickness direction of the compensation plate is equal to the retardation RthC in the thickness direction of the reflective liquid crystal element in absolute value and is the reverse of the retardation RthC in polarity. Therefore, a minute phase difference in the reflective liquid crystal element is cancelled by the compensation plate. As a result, compensation is provided for a change in the state of an angular deviation of a polarization axis of light modulated by the reflective liquid crystal element, and a further reduction in leakage light toward the screen is achieved when black is displayed. The single compensation plate provides the function of compensating for an angular deviation of a polarization axis and the function of compensating for a minute phase difference in the reflective liquid crystal element as thus described. It is therefore possible to avoid interfacial reflection of incident light which can occur, for example, when a quarter wave plate and a phase difference compensation plate are provided separately.

When the projection type liquid crystal display or the compensation plate according to the embodiments of the invention is used, an angular deviation of a polarization axis attributable to the direction of incidence of light impinging upon a polarization beam splitter can be suppressed to reduce leakage light toward a screen when black is displayed because the compensation plate has in-plane retardation Re which is one-fourth the wavelength of the incident light. The retardation RthL in the thickness direction of the compensation plate is equal to the retardation RthC in the thickness direction of the reflective liquid crystal element in absolute value and is the reverse of the retardation RthC in polarity. Thus, a minute phase difference in the reflective liquid crystal element can be canceled. As a result, compensation is made for a change in the state of an angular deviation of a polarization axis of light modulated by the reflective liquid crystal element, and a further reduction in leakage light toward the screen can be achieved when black is displayed. The single compensation plate provides the function of compensating for an angular deviation of a polarization axis and the function of compensating for a minute phase difference in the reflective liquid crystal element as thus described. It is therefore possible to avoid interfacial reflection of incident light which can occur, for example, when a quarter wave plate and a phase difference compensation plate are provided separately, and light can be more efficiently utilized. Since light from a light source can be more efficiently utilized while suppressing luminance in displaying black, a projection type liquid crystal display including a reflective liquid crystal element and a polarization beam splitter can be provided with contrast higher than that achievable in the related art.

### BRIEF DESCRIPTION OF THE DRAWINGS

FIG. 1 is an illustration showing a configuration of a projection type liquid crystal display according to an embodiment of the invention;

FIG. 2 is a perspective view showing an exemplary configuration of the compensation plate shown in FIG. 1;

FIGS. 3A and 3B are perspective views for explaining a method of fabricating the compensation plate shown in FIG. 2;

FIG. 4 is a perspective view showing another exemplary configuration of the compensation plate shown in FIG. 1;

FIGS. 5A and 5B are perspective views showing a detailed configuration of phase difference plates of the compensation plate shown in FIG. 4;

FIG. 6 is a perspective view showing another exemplary configuration of the compensation plate shown in FIG. 1;

FIGS. 7A and 7B are perspective views showing a detailed configuration of phase difference plates of the compensation plate shown in FIG. 6;

FIGS. 8A and 8B are perspective views showing optical paths and polarization axes of light beams impinging upon a polarization beam splitter as shown in FIG. 1 and light beams reflected at the same;

FIG. 9 is a perspective view of a polarization beam splitter as shown in FIG. 1 for explaining how leakage light is generated at the same;

FIG. 10 is an illustration showing a configuration of a projection type liquid crystal display according to Comparative Example 1;

FIG. 11 is a schematic plan view of a quarter wave plate as shown in FIG. 10 for explaining an effect of the same; and

FIG. 12 is an illustration showing a configuration of a projection type liquid crystal display according to Comparative Example 2.

### DESCRIPTION OF THE PREFERRED EMBODIMENTS

Embodiments of the invention will now be described in detail with reference to the drawings.

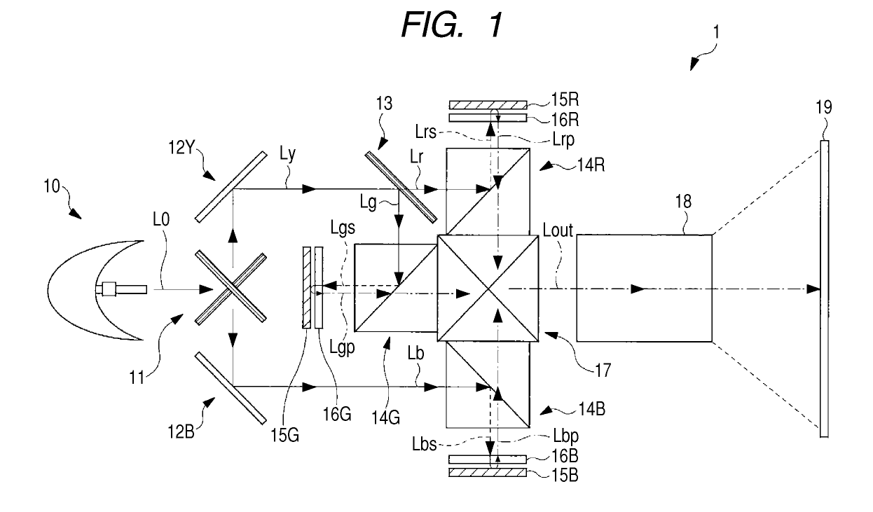

FIG. 1 shows a general configuration of a projection type liquid crystal display (liquid crystal projector) 1 according to an embodiment of the invention. The liquid crystal projector 1 displays an image based on an input image signal (not shown) supplied from outside. The liquid crystal projector 1 includes a light source unit 10, dichroic mirrors 11 and 13, reflecting mirrors 12B and 12Y, polarization beams splitters (PBSs) 14R, 14G, and 14B, reflective liquid crystal panels 15R, 15G, and 15B, compensation plates 16R, 16G, and 16B, a cross prism 17, and a projection lens 18.

The light source 10 emits white light (illumination light) L0 including light beams in primary colors, i.e., red light Lr, green light Lg, and blue light Lb which are necessary for color image display. For example, the light source may be a halogen lamp, metal halide lamp, or xenon lamp.

The dichroic mirror 11 color-separates the illumination light emitted from the light source 10 into blue light Lb and yellow light Ly which thereafter travel separately from each other. The dichroic mirror 13 transmits red light Lr included in the yellow light Ly color-separated by the dichroic mirror 11 and reflected by the reflecting mirror 12Y which will be described later and reflects green light Lg included in the yellow light, whereby red light Lr and the green light Lg are color-separated to travel separately from each other. The green light Lg reflected by the dichroic mirror 13 travels toward the PBS 14G which will be described later.

The reflecting mirror 12B reflects the blue light Lb color-separated by the dichroic mirror 11 toward the PBS 14B. The reflecting mirror 12Y reflects the yellow light Ly color-separated by the dichroic mirror 11 toward the dichroic mirror 13 and the PBS 14R.

The PBS 14R is disposed on an optical path between the light source 10 and the reflective liquid crystal panel 15R (specifically, an optical path between the dichroic mirror 13 and the reflective liquid crystal panel 15R). The PBS polarization-separates the red light Lr incident thereupon by reflecting an S-polarized component Lrs of the red light Lr on a polarization selection surface (a polarization selection surface 140 which will be described later) to guide the component toward the reflective liquid crystal panel 15R and transmitting a P-polarized component (not shown) of the red light. The PBS 14G is disposed on an optical path between the light source 10 and the reflective liquid crystal panel 15G (specifically, an optical path between the dichroic mirror 13 and the reflective liquid crystal panel 15G). The PBS polarization-separates the green light Lg incident thereupon by reflecting an S-polarized component Lgs of the green light Lg on a polarization selection surface (a polarization selection surface 140 which will be described later) to guide the component toward the reflective liquid crystal panel 15G and transmitting a P-polarized component (not shown) of the green light. The PBS 14B is disposed on an optical path between the light source 10 and the reflective liquid crystal panel 15B (specifically, an optical path between the reflecting mirror 12B and the reflective liquid crystal panel 15B). The PBS polarization-separates the blue light Lb incident thereupon by reflecting an S-polarized component Lbs of the blue light Lb on a polarization selection surface (a polarization selection surface 140 which will be described later) to guide the component toward the reflective liquid crystal panel 15B and transmitting a P-polarized component (not shown) of the blue light. The PBSs 14R, 14G, and 14B transmit P-polarized components Lrp, Lgp, and Lbp of the red light Lr, green light Lg, and blue light Lb which impinge upon the respective PBSs after being modulated by the reflective liquid crystal panels 15R, 15G, and 15B to guide the components toward the cross prism 17, although details of the operation will be described later.

The reflective liquid crystal panel 15R modulates the red light Lr incident thereupon (specifically, the S-polarized light component Lrs whose polarization axis has been converted by the compensation plate 16R which will be described later) based on an image signal (not shown) for red supplied from outside, and the panel reflects the modulated light toward the PBS 14R. The reflective liquid crystal panel 15G modulates the green light Lg incident thereupon (specifically, the S-polarized light component Lgs whose polarization axis has been converted by the compensation plate 16G which will be described later) based on an image signal (not shown) for green supplied from outside, and the panel reflects the modulated light toward the PBS 14G. The reflective liquid crystal panel 15B modulates the blue light Lb incident thereupon (specifically, the S-polarized light component Lbs whose polarization axis has been converted by the compensation plate 16B which will be described later) based on an image signal (not shown) for blue supplied from outside, and the panel reflects the modulated light toward the PBS 14B. Each of the reflective liquid crystal panels 15R, 15G, and 15B has a structure in which a vertical alignment type (e.g., VA mode) liquid crystal layer (not shown) is sandwiched between a pair of substrates (not shown) having a plurality of pixels (not shown) disposed in the form of a matrix, a driving voltage being applied to each pixel based on an image signal for the respective colors.

The compensation plate 16R is disposed on an optical path between the reflective liquid crystal panel 15R and the PBS 14R. The compensation plate 16G is disposed on an optical path between the reflective liquid crystal panel 15G and the PBS 14G. The compensation plate 16B is disposed on an optical path between the reflective liquid crystal panel 15B and the PBS 14B. The compensation plates 16R, 16G, and 16B are compensation plates which provide both of the function of correcting an angular deviation of an optical axis of incident light and the function of compensating for minute phase differences at the reflective liquid crystal panels 15R, 15G, and 15B. A detailed configuration of the compensation plates 16R, 16G, and 16B will be described later.

The cross prism 17 mixes the P-polarized components Lrp, Lgp, and Lbp of the red light Lr, green light Lg, and blue light Lb which have been modulated by the reflective liquid crystal panels 15R, 15G, and 15B, respectively, and transmitted through the PBSs 14R, 14G, and 14B to obtain mixed light (display light) Lout and directs the mixed light Lout to an optical path extending toward the projection lens 18.

The projection lens 18 is a lens which is disposed on an optical path between the cross prism 17 and a screen 19 and projects the display light Lout incident from the cross prism 17 toward the screen 19. The screen 19 is an area on which the light (display light) Lout modulated by the reflective liquid crystal panels 15R, 15G, and 15B, respectively, and projected by the projection lens 18 is projected.

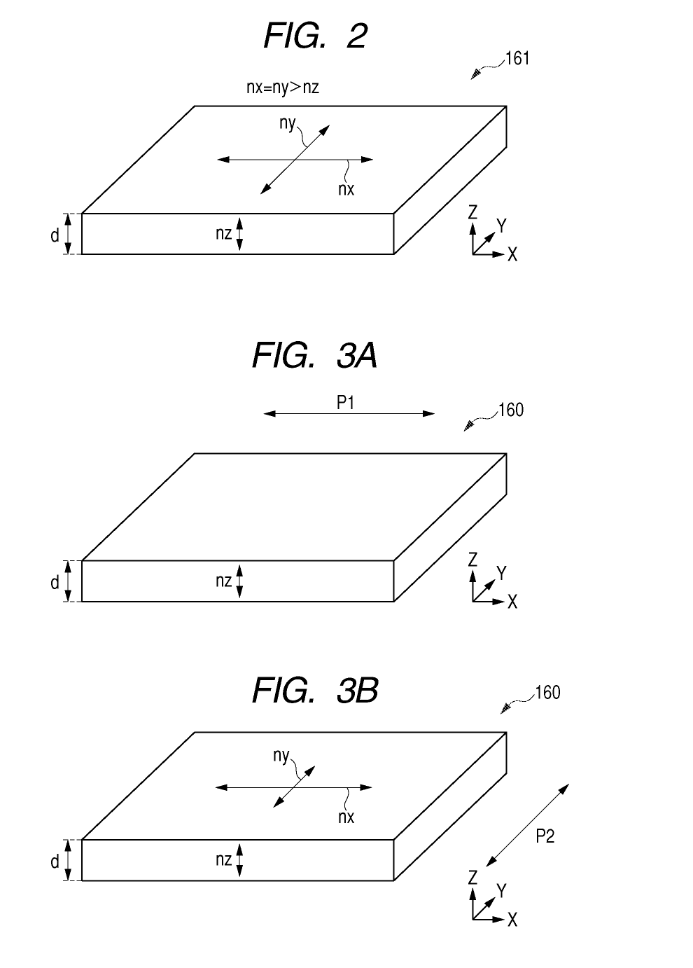

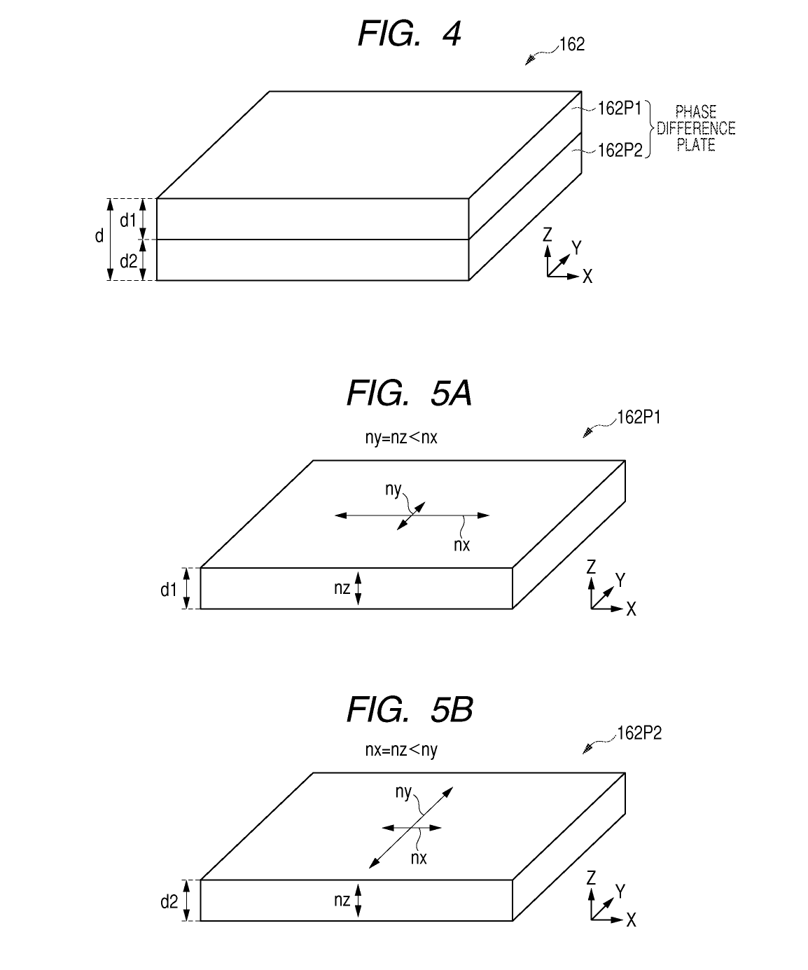

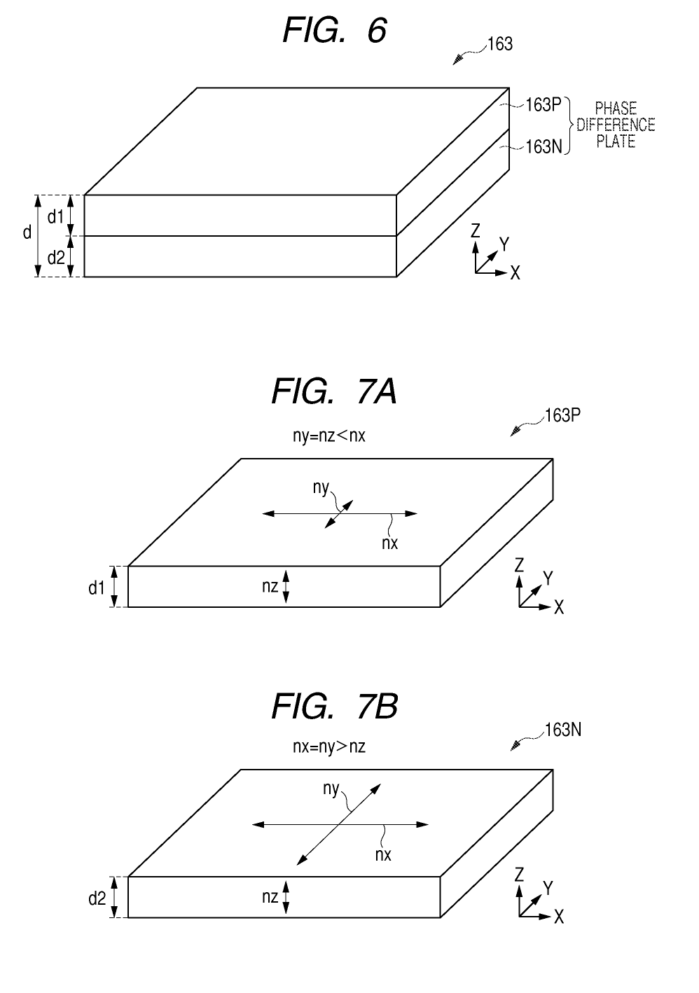

A configuration of the compensation plates 16R, 16G, and 16B (which will be referred to using a general term “compensation plates 16”) will be described in detail with reference to FIGS. 2 to 7. FIGS. 2 and 3 are perspective views showing a detailed configuration of an example of the compensation plates 16 (a compensation plate 161 which will be described later). FIGS. 4 and 5 are perspective views showing a detailed configuration of another example of the compensation plates 16 (a compensation plate 162 which will be described later). FIGS. 6 and 7 are perspective views showing a detailed configuration of still another example of the compensation plates 16 (a compensation plate 163 which will be described later).

The compensation plates 16 of the present embodiment have in-plane retardation Re which is one-fourth the wavelength of incident light (specifically, S-polarized components Lrs, Lgs, and Lbs or P-polarized components Lrp, Lgp, and Lbp of red light Lr, green light Lg, and blue light Lb). The compensation plates 16 have retardation RthL in the thickness direction thereof which is equal to retardation RthC in the thickness direction of reflective liquid crystal panels 15 (a general term representing the reflective liquid crystal panels 15R, 15G, and 15B) in absolute value and which is the reverse of the retardation RthC in polarity.

Specifically, Expressions 1 and 2 shown below are true where nx and ny represent refractive indices in in-plane directions of a compensation plate 16 (directions in an X-Y plane which will be described later); nz represents a refractive index in the thickness direction (a Z-axis direction which will be described later) of the compensation plate 16; d represents the thickness of the compensation plate 16; and λ represents the wavelength of light incident upon the compensation plate 16 (specifically, S-polarized components Lrs, Lgs, and Lbs or P-polarized components Lrp, Lgp, and Lbp of red light Lr, green light Lg, and blue light Lb).

(nx−ny)×d=λ/4 (1)

RthL=[{(nx+ny)/2}−nz]×d=RthC (2)

As will be understood from a compensation plate 161 shown in FIG. 2 by way of example, a compensation plate 16 having such refractive index characteristics is formed from a polymer film (e.g., a polymer film made of polycarbonate or a cyclic olefin type resin) biaxially stretched (stretched in an X-axis direction and a Y-axis direction) in in-plane directions (X-Y plane direction). Specifically, a relational expression nx=ny>nz is true between the refractive index nx in the X-axis direction, the refractive index ny in the Y-axis direction, and the refractive index nz in the Z-axis direction. For example, such a compensation plate 161 may be fabricated by stretching a polymer film 160 made of a material as described above in one axial direction indicated by arrow P1 (uniaxial stretching in the X-axis direction) as shown in FIG. 3A and thereafter stretching the polymer film 160 (whose refractive index nx in the X-axis direction has become greater than the refractive index ny in the Y-axis direction as a result of the uniaxial stretching in the X-axis direction) in one axial direction indicated by arrow P2 (uniaxial stretching in the Y-axis direction) as shown in FIG. 3B.

As will be understood from a compensation plate 162 shown in FIG. 4 by way of example, a compensation plate 16 may be made of a plurality (two in this example) of uniaxial phase difference plates (phase difference plates 162P1, 162P2) having positive refractive indices which are stacked and combined with each other (using an adhesive, for example) in the thickness direction thereof (in the Z-axis direction). Specifically, the phase difference plate 162P1 having a positive refractive index satisfies a relational expression ny=nz<nx as shown in FIG. 5A where nx, ny, and nz represent refractive indices of the plate in the X-axis, Y-axis, and Z-axis directions, respectively. The phase difference plate 162P2 having a negative refractive index satisfies a relational expression nx=ny<nz as shown in FIG. 5B where nx, ny, and nz represent refractive indices of the plate in the X-axis, Y-axis, and Z-axis directions, respectively. For example, the phase difference plates 162P1 and 162P2 are formed from a uniaxially stretched film or a liquid crystal polymer having positive refractive index anisotropy oriented in a predetermined direction.

As will be understood from a compensation plate 163 shown in FIG. 6 by way of example, such a compensation plate 16 may be formed by a uniaxial phase difference plate having positive refractive indices (phase difference plate 163P) and a uniaxial phase difference plate having negative refractive indices (phase difference plate 163N), the phase difference plates being stacked and combined with each other (using an adhesive, for example) in the thickness direction thereof (in the Z-axis direction). Specifically, the phase difference plate 163P having a positive refractive index satisfies a relational expression ny=nz<nx as shown in FIG. 7A where nx, ny, and nz represent refractive indices of the plate in the X-axis, Y-axis, and Z-axis directions, respectively. The phase difference plate 163N having a negative refractive index satisfies a relational expression nx=ny<nz as shown in FIG. 7B where nx, ny, and nz represent refractive indices of the plate in the X-axis, Y-axis, and Z-axis directions, respectively. For example, the phase difference plate 163P is formed from a uniaxially stretched film or a liquid crystal polymer having positive refractive index anisotropy oriented in a predetermined direction similarly to the phase difference plates 162P1 and 162P2. For example, the phase difference plate 163N is formed by stacking two or more dielectric films having different refractive indices alternately or forming helical layers of a cholesteric liquid crystal one over another.

Operations of the liquid crystal projector 1 of the present embodiment will now be described in detail in comparison to a comparative example, which will be described later, with reference to FIG. 1 and FIGS. 8 to 12.

In the liquid crystal projector 1, as shown in FIG. 1, illumination light L0 emitted by the light source 10 is color-separated by the dichroic mirror 11 into blue light Lb and yellow light Ly, and the yellow light Ly is further color-separated by the dichroic mirror 13 into red light Lr and green light Lg. The red light Lr obtained by color separation is polarization-separated by the PBS 14R, and a resultant S-polarized component Lrs impinges upon the reflective liquid crystal panel 15R through the compensation plate 16R. Similarly, the green light Lg obtained by color separation is polarization-separated by the PBS 14G, and a resultant S-polarized component Lgs impinges upon the reflective liquid crystal panel 15G through the compensation plate 16G. The blue light Lb obtained by color separation is polarization-separated by the PBS 14B, and a resultant S-polarized component Lbs impinges upon the reflective liquid crystal panel 15B through the compensation plate 16B. The light beams in the respective colors incident upon the reflective liquid crystal panels 15R, 15G, and 15B are modulated by the reflective liquid crystal panels 15R, 15G, and 15B, respectively, based on image signals (not shown) for the respective colors supplied from outside. The modulated light beams in the respective colors impinge upon the PBSs 14R, 14G, and 14B through the compensation plates 16R, 16G, and 16B (specifically, P-polarized components Lrp, Lgp, and Lbp of the red light Lr, green light Lg, and blue light Lb impinge upon the PBSs as will be detailed later). The light beams are transmitted by the PBSs 14R, 14G, and 14B to impinge upon the cross prism 17. The P-polarized components Lrp, Lgp, and Lbp of the red light Lr, green light Lg, and blue light Lb are mixed by the cross prism 17 into display light Lout. The display light Lout is projected on the screen 19 by the projection lens 18 to display an image based on the image signals.

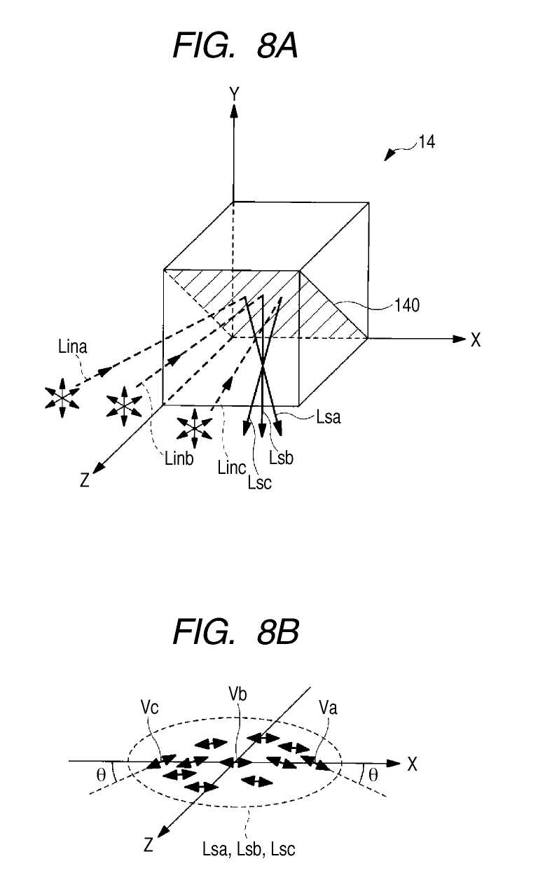

For example, let us discuss the operation using X, Y, and X axes as shown in FIG. 8A. Then, in the PBSs 14 (a general term representing the PBSs 14R, 14G, and 14B), light beams incident in a plane parallel to the X-Z plane (incident light beams Lina, Linb, and Linc associated with any of red light Lr, green light Lg, and blue light Lb) are reflected on a polarization selection surface 140 to become reflected light beams Lsa, Lsb, and Lsc, respectively, and the light beams travel in a plane parallel to the X-Y plane. The incident light beam Linb is a light beam which is parallel to the Z-axis, whereas the light beams Lina and Linc are light beams which are not parallel to the Z-axis. The light incident upon the polarization selection surface 140 is a set of light beams having various polarization axes (polarization angles) as thus described, whereas the light beams after reflected at the polarization selection surface 140 have S-polarized components only. As shown in FIG. 8B, the reflected light beams Lsa, Lsb, and Lsc including only S-polarized components have polarization axes Va, Vb, and Vc which are different from each other depending on the angles at which the respective incident light beams Lina, Linb, and Linc impinge upon the polarization selection surface 140. Specifically, the polarization axis Vb of the reflected light beam Lsb is parallel to the X-axis, whereas the polarization axes Va and Vc of the reflected light beams Lsa and Lsc define respective polarization angles θ in directions opposite to each other with respect to the X-axis.

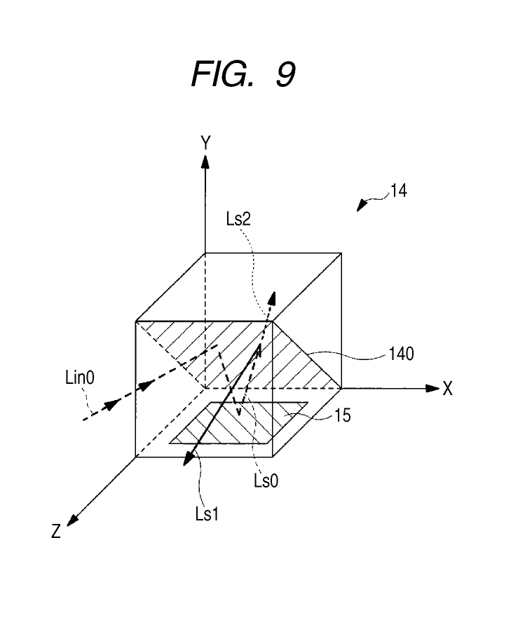

For example, let us discuss the reflected light beam Lsa shown in FIG. 8A on an assumption that it travels in the liquid crystal projector 1 of the present embodiment in which a reflective liquid crystal panel 15 is disposed in the traveling direction of a reflected light beam Ls0 from a PBS 14 (a reflected light beam obtained from an incident light beam Lin0) as shown in FIG. 9. Then, since the reflected light beam Lsa has the polarization axis Va, the reflected light beam Ls0 modulated and reflected by the reflective liquid crystal panel 15 is not entirely reflected at the polarization selection surface 140. Specifically, a major part of the reflected light beam Ls0 returns toward the light source 10 as return light Ls1, whereas some part of the reflected beam travels toward the screen 19 as leakage light Ls2. Such leakage light Ls2 generated at the PBS 14 results in an increase in leakage light components traveling toward the screen 19 when black is displayed, and a reduction in contrast consequently occurs.

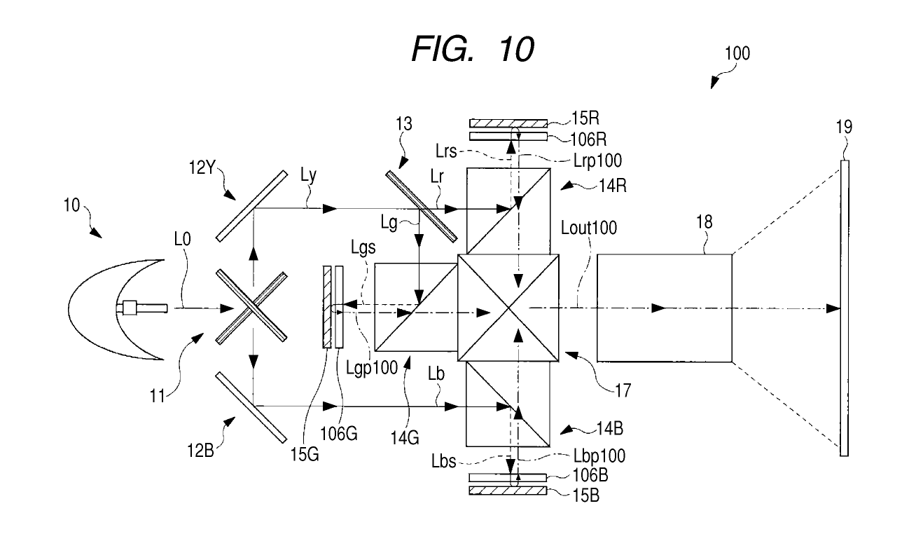

Under the circumstance, as shown in FIG. 10, in a projection type liquid crystal display (liquid crystal projector 100) according to the related art as Comparative Example 1, quarter wave plates 106R, 106G, and 106B are disposed on respective optical paths between PBSs 14R, 14G, and 14B and reflective liquid crystal panels 15R, 15G, and 15B. Thus, S-polarized components Lrs, Lgs, and Lbs of red light Lr, green light Lg, and blue light Lb pass through the quarter wave plates 106R, 106G, and 106B twice before they reach a cross prism 17, which results in an effect similar to that achieved by passing the light components through a half wave plate.

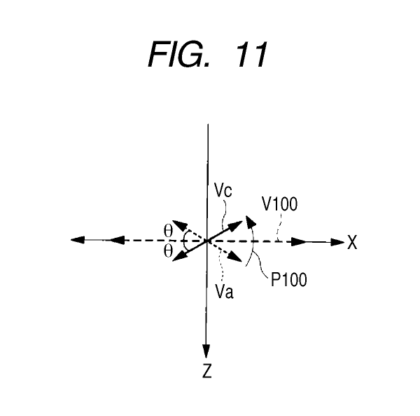

Specifically, when it is assumed that the quarter wave plates 106R, 106G, and 106B have a slow axis V100 which is in parallel with the X-axis, the polarization axis Va of the reflected light beam Lsa is rotated as indicated by arrow P100 in FIG. 11 to agree with the polarization axis Vc (the same thing occurs when the slow axis V100 is in parallel with the Y-axis).

As a result, the reflected light beam Ls0 in FIG. 9 has the polarization axis Vc, and the light beam is therefore totally reflected at the polarization selection surface 140. Thus, the generation of leakage light Ls2 is avoided (only return light Ls1 is generated). As thus described, in Comparative Example 1 in which quarter wave plates 106R, 106G, and 106B are disposed on respective optical paths between PBSs 14R, 14G, and 14B and reflective liquid crystal panels 15R, 15G, and 15B, angular deviations of polarization axes attributable to directions in which incident light impinges upon the PBSs 14R, 14G, and 14B are suppressed to reduce leakage light toward the screen 19 when black is displayed. Thus, luminance is kept low when black is displayed, and contrast is improved to some degree.

However, the liquid crystal projector 100 of Comparative Example 1 also has the above-described problem. Specifically, angular deviations of polarization axes of modulated light beams from the reflective liquid crystal panels 15R, 15G, and 15B can enter different states because of minute phase differences existing in the reflective liquid crystal panels 15R, 15G, and 15B. Sufficient compensation cannot be made for such changes in the state of angular deviations of the polarization axes with only the quarter wave plates 106R, 106G, and 106B, and leakage light toward the screen 19 cannot be sufficiently suppressed when black is displayed. As a result, the effect of improving contrast becomes insufficient.

Taking such a situation into consideration, in a projection type liquid crystal display (liquid crystal projector) 200 as Comparative Example 2, in addition to quarter wave plates 106R, 106G, and 106B as thus described, compensation plates 206R, 206G, and 206B for compensating for minute phase differences in reflective liquid crystal panels 15R, 15G, and 15B are provided on optical paths between PBSs 14R, 14G, and 14B and the quarter wave plates 106R, 106G, and 106B.

However, it is difficult to suppress leakage light sufficiently taking both of correction of angular deviations of polarization axes and compensation for minute phase differences at the reflective liquid crystal panels 15R, 15G, and 15B into account by simply providing such additional compensation plates 206R, 206G, and 206B. Specifically, the function of correcting angular deviations of polarization axes and the function of compensating for minute phase differences at the reflective liquid crystal elements are achieved by the quarter wave plates 106R, 106G, and 106B and the compensation plates 206R, 206G, and 206B. Therefore, reflections occur at interfaces of the quarter wave plates 106R, 106G, and 106B and the compensation plates 206R, 206G, and 206B (interfaces between those plates and layers of air which are present between the plates), and the utilization of the illumination light L0 from the light source 10 is reduced. Therefore, sufficiently high contrast cannot be achieved also in the liquid crystal projector 200 of Comparative Example 2.

On the contrary, in the liquid crystal projector 1 of the present embodiment, the in-plane retardation Re of the compensation plates 16R, 16G, and 16B is one-fourth the wavelength of incident light (specifically, S-polarized components Lrs, Lgs, and Lbs or P-polarized components Lrp, Lgp, and Lbp of red light Lr, green light Lg, and blue light Lb). Therefore, the compensation plates 16R, 16G, and 16B serve as quarter wave plates in the frontal direction. As a result, the compensation plates suppress angular deviations of polarization axes attributable to the direction in which the incidence impinges upon the PBSs 14R, 14G, and 14B in the same way as the quarter wave plates 106R, 106G, and 106B of Comparative Example 1 operates, and leakage light toward the screen 19 is therefore reduced when black is displayed.

The compensation plates 16R, 16G, and 16B have the retardation RthL in the thickness direction which is equal to the retardation RthC in the thickness direction of the reflective liquid crystal panels 15R, 15G, and 15B in absolute value and which is the reverse of the retardation RthC in polarity. Therefore, minute phase differences in the reflective liquid crystal panels 15R, 15G, and 15B are canceled by the compensation plates 16R, 16G, and 16B. As a result, compensation is made for changes in the state of angular deviations of polarization axes of light modulated by the reflective liquid crystal panels 15R, 15G, and 15B, and a further reduction of leakage light toward the screen 19 is achieved when black is displayed.

Further, the function of correcting angular deviations of polarization axes and the function of compensating for minute phase differences at the reflective liquid crystal panels 15R, 15G, and 15B as thus described are provided by the compensation plates 16R, 16G, and 16B alone. It is therefore possible to avoid interfacial reflections of incident light which can occur when the quarter wave plates 106R, 106G, and 106B and the phase difference compensation plates 206R, 206G, and 206B are provided separately from each other as in Comparative Example 2.

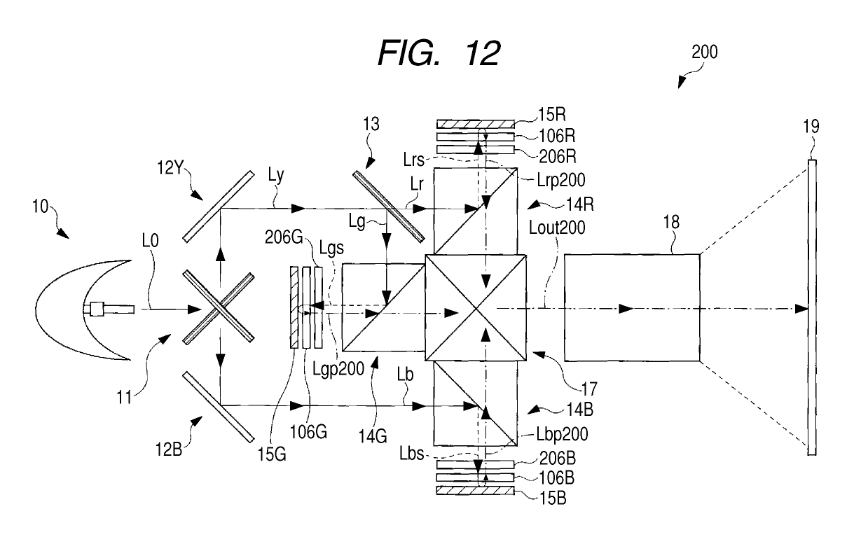

TABLE 1

| | Compensator | Light Bulb | Contrast | Outline |
|---|---|---|---|---|
| Comparative | ¼ Wave Plate | Reflective | 4100:1 | FIG. 10 |
| Example 1 | | LC Panel | | |
| Comparative | ¼ Wave Plate + | Reflective | 4000:1 | FIG. 12 |
| Example 2 | Plate 206 | LC Panel | | |
| Embodiment 1 | Plate 163 | Reflective | 5500:1 | FIG. 1 |
| | | LC panel | | |

Table 1 shows results of measurement of contrast carried out on Comparative Examples 1 and 2 and Embodiment 1 (an embodiment of the liquid crystal projector 1 in which compensation plates 163 as shown in FIGS. 6 and 7 are used). Contrast was measured on the screens 19 of the liquid crystal projectors 1, 100, and 200 using a luminance meter when each of the projectors displayed white and black. Table 1 indicates that Embodiment 1 employing the compensation plates 163 had a contrast level 30 to 40% higher than those of Comparative Example 1 employing the quarter wave plates 106R, 106G, and 106B and Comparative Example 2 employing the phase difference compensation plates 206R, 206G, and 206B in addition to the quarter wave plates 106R, 106G, and 106B. Although not shown in Table 1, it has been revealed that measured values of contrast similar to that of Embodiment 1 can be obtained in another embodiment of the liquid crystal projector 1 employing compensation plates 161 as shown in FIGS. 2 and 3 and in still another embodiment employing compensation plates 162 as shown in FIGS. 4 and 5.

As described above, in the embodiment of the invention, the in-plane retardation Re of the compensation plates 16R, 16G, and 16B are one-fourth the wavelength of incident light (specifically, S-polarized components Lrs, Lgs, and Lbs or P-polarized components Lrp, Lgp, and Lbp of red light Lr, green light Lg, and blue light Lb). It is therefore possible to suppress angular deviations of polarization axes attributable to the directions in which the incident light impinges upon the PBSs 14R, 14G, and 14B and to reduce leakage light toward the screen 19 when black is displayed. The compensation plates 16R, 16G, and 16B have the retardation RthL in the thickness direction which is equal to the retardation RthC in the thickness direction of the reflective liquid crystal panels 15R, 15G, and 15B in absolute value and which is the reverse of the retardation RthC in polarity. Thus, minute phase differences at the reflective liquid crystal panels 15R, 15G, and 15B can be canceled. As a result, it is possible to compensate for changes in the state of angular deviations of polarization axes of light beams modulated by the reflective liquid crystal panels 15R, 15G, and 15B, and a further reduction of leakage light toward the screen 19 can be achieved when black is displayed. The function of correcting angular deviations of polarization axes and the function of compensating for minute phase differences at the reflective liquid crystal panels 15R, 15G, and 15B are provided by the compensation plates 16R, 16G, and 16B alone. It is therefore possible to avoid interfacial reflections of incident light which can occur when quarter wave plates and phase difference compensation plates are provided separately, and the utilization of light can be improved. Thus, luminance can be kept low when black is displayed, and the illumination light L0 from the light source 10 can be utilized with improved efficiency. As a result, the liquid crystal projector including reflective liquid crystal panels and PBSs can be provided with contrast higher than that in the related art.

Specifically, the above-described effects can be achieved because the reflective liquid crystal panels 15R, 15G, and 15B include vertically aligned liquid crystal layers and the compensation plates satisfy Expressions 1 and 2 shown above.

When the compensation plates 16 are formed from polymer films biaxially stretched in in-plane directions thereof (compensation plates 161), a significant reduction can be achieved in the manufacturing cost, and the utilization of light can be significantly improved to achieve a significant improvement of contrast.

Retardation can be easily adjusted using refractive indices when the compensation plates 16 are formed by a plurality of uniaxial phase difference plates having positive refractive indices which are combined with each other in the thickness direction (compensation plates 162) or when the plates 16 are formed by a uniaxial phase difference plate having a positive refractive index and a uniaxial phase difference plate having a negative refractive index which are combined with each other in the thickness direction (compensation plates 163). In such cases, since the compensation plates are formed by combining a plurality of uniaxial phase difference plates, it is preferable to suppress reflections at interfaces between the uniaxial phase difference plates by keeping differences between the refractive indices of the plates as small as possible. The reason is that suppression of reflections allows utilization of light at higher efficiency and allows a further improvement of contrast.

While the invention has been described with reference to the embodiments, the invention is not limited to the embodiments but can be embodied in various modifications.

For example, although the above embodiment has been described on an assumption that the reflective liquid crystal panels 15R, 15G, and 15B include vertical alignment type (e.g., VA mode) liquid crystal layers, the reflective liquid crystal panels 15R, 15G, and 15B may alternatively include, for example, twisted vertical alignment type liquid crystal layers (liquid crystal layers which are vertically aligned and in which liquid crystal molecules are twist-aligned in an interlayer direction). In this case, the same effects as those of the above-described embodiment can be achieved when Equations 3 and 4 shown below are true.

(nx−ny)×d=λ/4 (3)

RthL=[{(nx+ny)/2}−nz]×d=−RthC (4)

Although the above embodiment has been described on an assumption that the light source 10 includes a halogen lamp, a metal halide lamp, or a xenon lamp, the light source 10 may alternatively include, for example, a light-emitting diode (LED).

Although the above embodiment has been described as a so-called three-plate type projection liquid crystal display (liquid crystal projector), the invention may be applied to other types of projection liquid crystal displays.

It should be understood by those skilled in the art that various modifications, combinations, sub-combinations and alternations may occur depending on design requirements and other factors insofar as they are within the scope of the appended claims or the equivalents thereof.

What is claimed is:

1. A projection type liquid crystal display comprising:
a light source;
a reflective liquid crystal element modulating light from the light source based on an image signal;
a polarization beam splitter disposed on an optical path between the light source and the reflective liquid crystal element;
a compensation plate disposed on an optical path between the reflective liquid crystal element and the polarization beam splitter; and
projection means for projecting light impinging thereon through an optical path extending through the compensation plate and the beam splitter upon a screen, the light impinging upon the projection means after being modulated by the reflective liquid crystal element,
the compensation plate having in-plane retardation Re which is one-fourth the wavelength of light impinging upon the compensation plate,
the compensation plate having retardation RthL in the direction of the thickness thereof which is equal to retardation RthC in the thickness direction of the reflective liquid crystal element in absolute value and which is the reverse of the retardation RthC in polarity.

2. A projection type liquid crystal display according to claim 1, wherein
the reflective liquid crystal element includes a vertical alignment type liquid crystal layer, and
Expressions 1 and 2 are true where nx and ny represent refractive indices in in-plane directions of the compensation plate; nz represents a refractive index in the thickness direction of the compensation plate; d represents the thickness of the compensation plate; and λ represents the wavelength of light incident upon the compensation plate:
(nx−ny)×d=λ/4 (1)
RthL=[{(nx+ny)/2}−nz]×d=RthC (2).

3. A projection type liquid crystal display according to claim 1, wherein
the reflective liquid crystal element includes a liquid crystal layer which is a vertical alignment type and in which liquid crystal molecules are twist-aligned in an interlayer direction, and
Expressions 3 and 4 are true where nx and ny represent refractive indices in in-plane directions of the compensation plate; nz represents a refractive index in the thickness direction of the compensation plate; d represents the thickness of the compensation plate; and λ represents the wavelength of light incident upon the compensation plate:
(nx−ny)×d=λ/4 (3)
RthL=[{(nx+ny)/2}−nz]×d=−RthC (4).

4. A projection type liquid crystal display according to claim 1, wherein the compensation plate includes a polymer film which is biaxially stretched in in-plane directions.

5. A projection type liquid crystal display according to claim 1, wherein the compensation plate includes a plurality of uniaxial phase difference plates having a positive refractive index which are combined with each other in the thickness direction thereof.

6. A projection type liquid crystal display according to claim 1, wherein the compensation plate includes a uniaxial phase difference plate having a positive refractive index and a uniaxial phase difference plate having a negative refractive index which are combined with each other in the thickness direction thereof.

7. A compensation plate of a projection type liquid crystal display including a light source, a reflective liquid crystal element modulating light from the light source based on an image signal, a polarization beam splitter disposed on an optical path between the light source and the reflective liquid crystal element, and projection means for projecting light impinging thereon through an optical path extending through the beam splitter upon a screen, the light impinging upon the projection means after being modulated by the reflective liquid crystal element,
the compensation plate being used on an optical path between the reflective liquid crystal element and the polarization beam splitter and having in-plane retardation Re which is one-fourth the wavelength of light impinging upon the compensation plate and retardation RthL in the thickness direction thereof which is equal to retardation RthC in the thickness direction of the reflective liquid crystal element in absolute value and which is the reverse of the retardation RthC in polarity.

8. A projection type liquid crystal display comprising:
a light source;
a reflective liquid crystal element modulating light from the light source based on an image signal;
a polarization beam splitter disposed on an optical path between the light source and the reflective liquid crystal element;
a compensation plate disposed on an optical path between the reflective liquid crystal element and the polarization beam splitter; and
a projection unit configured to project light impinging thereon through an optical path extending through the compensation plate and the beam splitter upon a screen, the light impinging upon the projection unit after being modulated by the reflective liquid crystal element,
the compensation plate having in-plane retardation Re which is one-fourth the wavelength of light impinging upon the compensation plate,
the compensation plate having retardation RthL in the direction of the thickness thereof which is equal to retardation RthC in the thickness direction of the reflective liquid crystal element in absolute value and which is the reverse of the retardation RthC in polarity.
